(19) United States
(12) Patent Application Publication
(10) Pub. No.: US 2008/0223723 A1
(43) Pub. Date: Sep. 18, 2008

(54) METHOD FOR MANUFACTURING MASTER INFORMATION CARRIER FOR MAGNETIC TRANSFER

(75) Inventor: Yanlong CHE, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/047,079

(22) Filed: Mar. 12, 2008

(30) Foreign Application Priority Data
Mar. 13, 2007 (JP) 2007-063691

(51) Int. Cl. G11B 3/70

(52) U.S. Cl. 205/68

(57) ABSTRACT

There is provided a method for manufacturing a high quality master information carrier for magnetic transfer, the method preventing the metallic disk formed by electroforming from coming off from the conduction ring and decreasing the distortion of the master information carrier. A conduction ring connected to a cathode is arranged on a matrix and electroforming is performed with the conduction ring being smaller in bore diameter than a presser ring for fixing the conduction ring and the matrix.

### BACKGROUND OF THE INVENTION

1. Field of the Invention

The present invention relates to a method for manufacturing a master information carrier for magnetic transfer, and in particular, to a method for manufacturing a master information carrier for magnetic transfer suitable for transferring magnetic information such as format information to a magnetic disk used in a hard disk device.

2. Description of the Related Art

In general, a magnetic disk (hard disk) used in a hard disk drive which has been rapidly prevailing in recent years is delivered from a magnetic disk manufacturer to a hard disk drive manufacturer, and then format and address information is written in the magnetic disk before it is incorporated in the-hard disk drive. Although the writing may be performed by using a magnetic head, it is effective and preferable to collectively transfer information by a master disk being a master information carrier in which format and address information is written.

The method for performing a collective magnetic transfer is such that the master disk is brought into close contact with a receiver disk (or a slave disk) and a magnetic field generating device such as an electric magnet device or a permanent magnet device is disposed on one face or both faces thereof to apply a transferring magnetic field thereto to magnetically transfer information (for example, a servo signal) on the surface of the master disk to the slave disk. It is extremely important to uniformly bring the master disk into close contact with the slave disk with no space therebetween.

A master disk for magnetic transfer is described below. FIG. 1 is a partial perspective view of a master disk 10 for magnetic transfer (hereinafter, referred to as master disk 10). FIG. 2 is a cross section taken along the line A-A of FIG. 1. A receiver disk (slave disk 14) is shown by an imaginary line.

As illustrated in FIGS. 1 and 2, the master disk 10 is consisted of a metallic master substrate 11 and a magnetic layer 12. The master substrate 11 has a fine concave-convex pattern P (for example, servo information pattern) corresponding to transfer information on its surface and the concave-convex pattern P is covered with the magnetic layer 12.

This forms an information-bearing surface 13 having the fine concave-convex pattern P covered with the magnetic layer 12 on one face of the master substrate 11. As can be seen from FIG. 1, the fine concave-convex pattern P has a rectangular shape in plan view which is defined by a length “p” in the track direction (the direction indicated by an arrow in the FIG. 1) and a length “L” in the radial direction in the case where the magnetic layer is formed.

The optimum values of the lengths “p” and “L” are different depending upon recording density and recording signal waveforms, however, they may be, for example, 80 nm and 200 nm respectively. The fine concave-convex pattern P is formed extendedly in the radial direction for the case of a servo signal. In this case, it is preferable that the length “L” in the radial direction is 0.05 μm to 20 μm and the length “p” in the track direction (or, circumference direction) is 0.01 μm to 5 μm, for example.

It is preferable to select as a pattern bearing a servo signal the fine concave-convex pattern P of which the radial direction is longer than the track direction within the above range. The concave-convex pattern P is preferably 30 nm to 800 nm in depth “t” (or, height of the projection) and more preferably 50 nm to 300 nm.

The master substrate 11 is produced by electroforming. As illustrated in FIG. 3, the master substrate 11 is formed to be of a disk shape with a center hole 11G and the concave-convex pattern P is formed in an annular area 11F excluding an inner peripheral portion 11D and an outer peripheral portion 11E on one face (or, the information-bearing surface 13) of the master substrate 11. The master disk 10 is generally produced by: an electroforming step for electroforming a layer on a matrix on which information is formed by the concave-convex pattern P to make a metallic disk composed of an electroformed layer deposit and transferring the concave-convex pattern P to the surface of the metallic disk; a detachment step for detaching the metallic disk is detached from the matrix; and covering step for covering the concave-convex pattern P on the surface with a magnetic layer after a master substrate 11 is produced through a punching process for punching the detached metallic disk to a predetermined size (refer to Japanese Patent Application Laid-Open No. 2001-256644, for example).

The configuration of an electroforming apparatus used for manufacturing a master information carrier for magnetic transfer is described below. FIG. 4 is a cross section of an electroforming apparatus 60. The electroforming apparatus 60 includes a plating tank 64 for storing plating liquid (bath) 62, a drain tank 66 for receiving the plating liquid 62 overflowing the plating tank 64, an anode chamber 70 which is filled with Ni pellets 68 as anode and receives the plating liquid 62 overflowing the plating tank 64, and a cathode 72 for holding the matrix.

The plating tank 64 is designed to be supplied with the plating liquid 62 by a plating liquid supplying pipe 74. The plating liquid 62 overflowing the plating tank 64 into the drain tank 66 is designed to be recovered by a drain tank draining pipe 76. The plating liquid 62 overflowing the plating tank 64 into the anode chamber 70 is designed to be recovered by an anode chamber draining pipe 78.

The plating tank 64 is separated from the anode chamber 70 by a bulkhead 80. An electrode shielding plate 82 is fixed opposite to the cathode 72 on the surface of the bulkhead 80 on the side of the plating tank 64. The electrode shielding plate 82 is formed to cover a predetermined portion of the electrode to uniform the thickness of an electroformed film in plane.

In the electroforming apparatus 60 with the above configuration, the cathode 72 holds the matrix and is connected to a negative electrode, and the anode chamber 70 is connected to the positive electrode to energize, thereby electroforming the master substrate 11.

FIG. 5 is a cross section illustrating the configuration of the cathode 72. The cathode 72 includes a cathode main body 84 being a disklike member with a flange portion 84A, a conduction ring 86, a presser ring 88 and a shaft 90.

The matrix 17 can be placed on the surface of the cathode main body 84 in this state (attitude) in FIG. 5. As materials for the cathode main body 84 there may be used various kinds of metallic materials which do not cause degradation such as rust owing to the use of them in the electroforming apparatus 60.

The conduction ring 86 is arranged on the matrix 17. As materials for the conduction ring 86 there may be used various kinds of metallic materials, for example, stainless steel or titanium, which do not cause degradation such as rust owing to the use of them in the electroforming apparatus 60.

The presser ring 88 is a ring member which is the same in bore diameter as the conduction ring 86 and prevents the conduction ring 86 and the matrix 17 from coming off from the cathode main body 84 when the presser ring 88 is fixed to the cathode main body 84, for example, by a bolt member (not shown). As materials for the presser ring 88 there may be used various kinds of resin materials such as polyvinyl chloride (PVC) and the like.

The shaft 90 is a cylindrical member which is detachably fixed to the central portion of the lower face of the cathode main body 84. As materials for the shaft 90 there may be used various kinds of metallic materials which do not cause degradation such as rust owing to the use of them in the electroforming apparatus 60.

By electroforming with use of the above electroforming apparatus 60, the plating liquid 62 deposits to turn it into a metallic disk 18 with a desired thickness inside the conduction ring 86 on the matrix 17. After that, the metallic disk 18 is detached from the matrix 17, washed and punched to produce the master substrate 11 with a predetermined size. A magnetic layer 12 is formed on the surface of the concave-convex pattern of the master substrate 11 to enable the master disk 10 to be produced.

The conventional master disk 10 produced by the above process, however, tends to cause an internal stress in a layer formed by electroforming and is less flat, i.e., has warp and distortion due to deformation, etc., caused at the detachment step for detaching the metallic disk 18 from the matrix 17, the washing step and the punching step.

It is important to bring the master disk 10 into close contact with the slave disk 14 with no space therebetween so as to satisfactorily perform the magnetic transfer of signals. However, as described above, the distortion is caused in the master disk 10, so that the following adjustments are performed: a contact pressure which is applied to bring the master disk 10 into close contact with the slave disk 14 is increased at the time of transfer; or a flatness of a holder for holing the master disk 10 is increased.

However, increasing the above contact pressure may break or deform the concave-convex pattern formed on the master disk 10 and results in decrease in durability of the master disk 10. For this reason, the master disk 10 has been further thinned to improve a close-contact characteristic. The thickness of the master disk 10 is required to be 300 μm or less.

In the method for manufacturing such a master information carrier, the metallic disk 18 deposited at the electroforming step contacts the conduction ring 86 only at a narrow area in its inner periphery.

For this reason, the thinned metallic disk 18 (for example, a thickness of 30 μm to 200 μm) conveyed along with the conduction ring 86 after the metallic disk 18 has been detached from the matrix 17 is liable to come off from the conduction ring 86 if an external force is applied to the metallic disk 18, causing a significant deformation on the detached metallic disk 18.

The master disk 10 produced by the metallic disk 18 to which such an external force is applied is significantly distorted and is inferior in a transfer characteristic, which degrades the quality of a transferred product and decreases productivity and manufacturing efficiency.

### SUMMARY OF THE INVENTION

The present invention has been made in view of the above problems and for its object to provide a method for manufacturing a high quality master information carrier for magnetic transfer, the method preventing the metallic disk from coming off from the conduction ring and decreasing the distortion of the master information carrier.

To achieve the above object, according to a first aspect of the invention, a method for manufacturing a master information carrier for magnetic transfer on the surface of which a concave-convex pattern corresponding to transfer information is provided, comprises the step of: arranging a conduction ring on a matrix on the surface of which a concave-convex pattern corresponding to transfer information is formed; and forming a metallic layer by electroforming on the matrix, wherein the conduction ring is smaller in bore diameter than a presser ring which fixes the conduction ring and the matrix.

According to the first aspect, the conduction ring connected to an electrode is arranged on the matrix for manufacturing a master information carrier for magnetic transfer, on which a fine concave-convex pattern is formed. The conduction ring and the matrix are fixed by the presser ring, and the conduction ring is smaller in bore diameter than the presser ring.

The metallic disk deposited by electroforming on the matrix is deposited not only on the inner peripheral surface of the conduction ring, but also on the plane portion of the conduction ring where the presser ring does not touch. Thereby, the metallic disk is integrated with the conduction ring, which prevents the metallic disk from coming off from the conduction ring. For this reason, even if an unnecessary external force is applied to the metallic disk, the metallic disk does not come off from the conduction ring. Thus, it enables to reduce the distortion of the metallic disk, and to produce a high quality master information carrier for magnetic transfer.

According to a second aspect of the present invention, in the method for manufacturing a master information carrier for magnetic transfer according to the first aspect, the inner peripheral surface of the conduction ring is tapered.

According to the second aspect of the invention, the metallic disk deposited by electroforming is readily deposited on the inner peripheral surface of the conduction ring formed in a taper shape and a plane portion of the conduction ring where the presser ring does not touch. Thereby, the metallic disk is integrated with the conduction ring, which prevents the metallic disk from coming off from the conduction ring. For this reason, even if an unnecessary external force is applied to the metallic disk, the metallic disk does not come off from the conduction ring. Thus, it enables to reduce the distortion of the metallic disk, and to produce a high quality master information carrier for magnetic transfer.

According to a third aspect of the present invention, in the method for manufacturing a master information carrier for magnetic transfer according to the first aspect, the inner peripheral surface of the conduction ring is stepped.

According to the third aspect of the invention, the metallic disk deposited by electroforming is readily deposited on the stepped inner peripheral surface of the conduction ring and a plane portion of the conduction ring where the presser ring does not touch. Thereby, the metallic disk is integrated with the conduction ring to prevent the metallic disk from coming off from the conduction ring. For this reason, even if an unnecessary external force is applied to the metallic disk, the metallic disk does not come off from the conduction ring. Thus, it enables to reduce the distortion of the metallic disk, and to produce a high quality master information carrier for magnetic transfer.

According to a fourth aspect of the present invention, in the method for manufacturing a master information carrier for magnetic transfer according to any one of the aspects first, second and third, the metallic layer is electroformed on the matrix, the inner peripheral surface of the conduction ring and a plane portion of the conduction ring where the presser ring does not touch.

According to the fourth aspect, the metallic layer deposited by electroforming is deposited on the matrix, the tapered portion or the step portion of the inner peripheral surface of the conduction ring and the plane portion of the conduction ring where the presser ring does not touch.

This integrates the metallic disk with the conduction ring to prevent the metallic disk from coming off from the conduction ring. For this reason, even if an unnecessary external force is applied to the metallic disk, the metallic disk does not come off from the conduction ring. Thus, it enables to reduce the distortion of the metallic disk, and to produce a high quality master information carrier for magnetic transfer.

According to a fifth aspect of the present invention, in the method for manufacturing a master information carrier for magnetic transfer according to any one of the aspects first, second, third, and fourth, the concave-convex pattern is formed on the surface of the inner peripheral surface of the conduction ring.

According to the fifth aspect, a contact area where the metallic disk deposited by electroforming touches the conduction ring is increased to more tightly integrate the metallic disk with the conduction ring. This enables to prevent the metallic disk from coming off from the conduction ring.

According to a sixth aspect of the present invention, in the method for manufacturing a master information carrier for magnetic transfer according to any one of the aspects first, second, third, fourth and fifth, the bore diameter of presser ring is larger than that of the conduction ring and the bore diameter of the conduction ring is larger than the outer diameter of the master information carrier.

According to the sixth aspect, the bore diameter of the presser ring is larger than that of the conduction ring, which enables to leave a plane portion in the conduction ring on which metal is deposited. Thereby, the metal is deposited on the plane portion to more tightly integrate the metallic disk with the conduction ring. In addition, the bore diameter of the conduction ring is larger than the outer diameter of a master information carrier to be produced, which does not cause a problem in the master information carrier to be produced.

As described above, according to the method for manufacturing a master information carrier for magnetic transfer of the aspects of the present invention, the electroformed metallic disk is more tightly integrated with the conduction ring to prevent the metallic disk from coming off from the conduction ring. This enables to reduce distortion in the master information carrier, and therefore allows manufacturing a high quality master information carrier for magnetic transfer.

### BRIEF DESCRIPTION OF THE DRAWINGS

FIG. 1 is a partial perspective view of a master disk of the present invention;

FIG. 2 is a cross section taken along the line A-A of FIG. 1;

FIG. 3 is a top plane view of a master substrate;

FIG. 4 is a cross section of an electroforming apparatus;

FIG. 5 is a cross section illustrating the configuration of a cathode;

FIGS. 6A, 6B, 6C, 6D and 6E are process charts of the method for manufacturing a master disk according to one embodiment of the present invention;

FIG. 7 is a cross section illustrating an exemplary configuration of the cathode of the present invention;

FIG. 8 is a cross section illustrating an exemplary configuration of a second cathode of the present invention;

FIG. 9 is a cross section illustrating an exemplary configuration of a third cathode of the present invention;

FIG. 10 is a table showing comparison result of distortion of 150-μm thick master substrates;

FIG. 11 is a table showing comparison result of distortion of 50-μm thick master substrates; and

FIG. 12 is a table showing the probability that the metallic disk 18 comes off from the conduction ring.

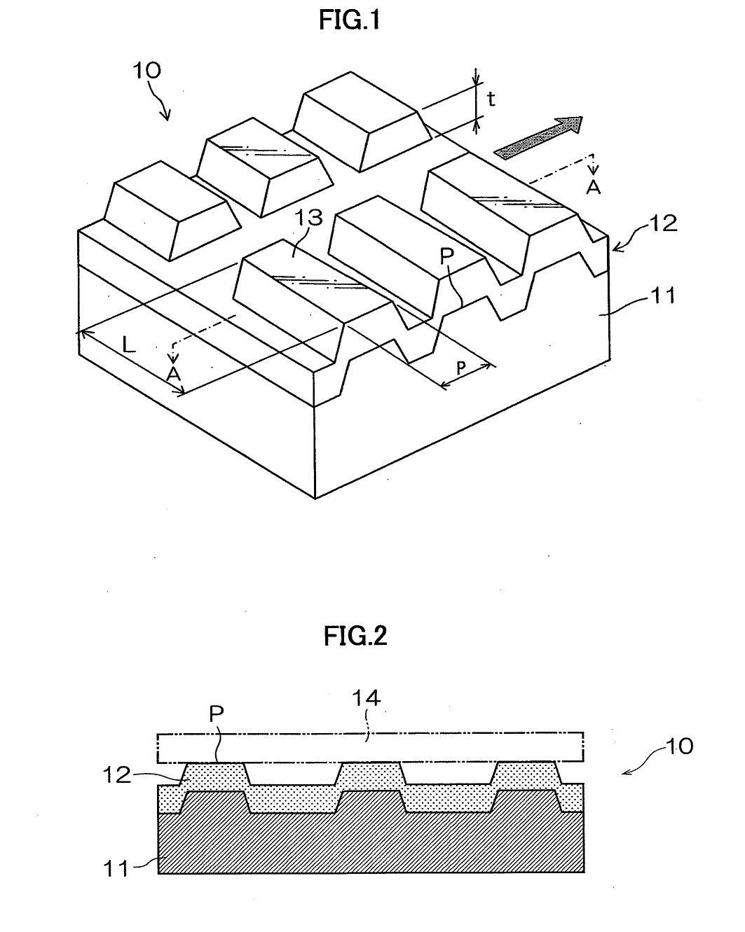

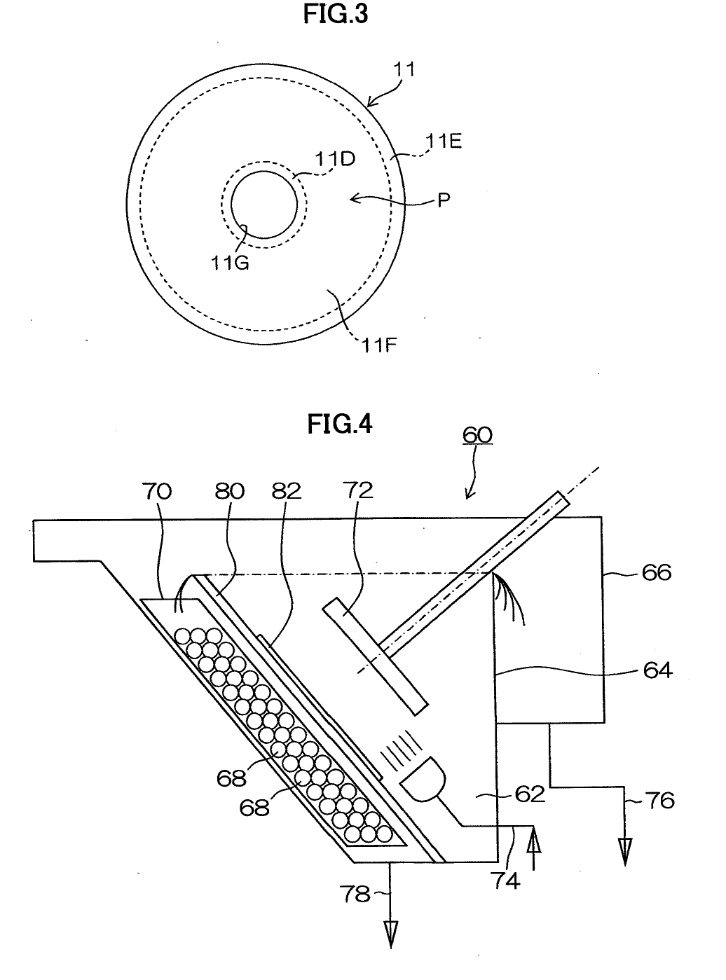

### DETAILED DESCRIPTION OF THE PREFERRED EMBODIMENTS

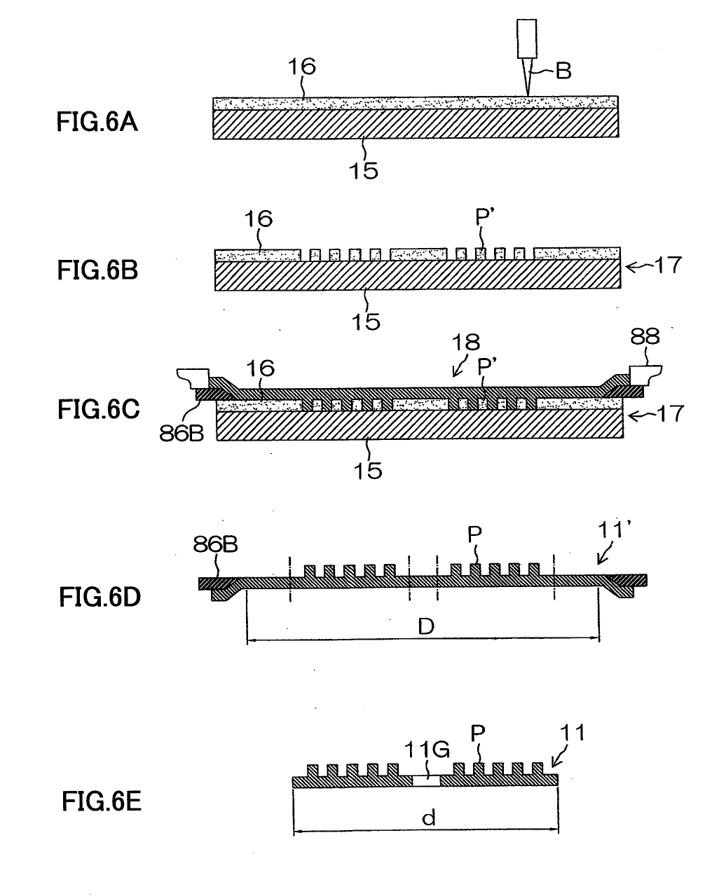

A preferable embodiment of the method for manufacturing a master information carrier for magnetic transfer according to the present invention is described below with reference to the accompanying drawings. FIGS. 6A, 6B, 6C, 6D and 6E are process charts illustrating steps for manufacturing the master disk 10. As illustrated in FIG. 6A, a primitive plate 15 made of silicon wafer (or made of glass plate or quartz plate) whose surface is smooth and clean is subjected to pretreatment such as the formation of an adherence layer, coated with electron beam resist liquid by a spin coater or the like to form a resist film 16 and baked.

The primitive plate 15 mounted on a stage is irradiated with an electron beam B modulated in correspondence with a servo signal or the like by an electron beam exposure apparatus (not shown) equipped with a highly accurate rotary stage or X-Y stage to draw and expose a desired concave-convex pattern P′ on the resist film 16.

As illustrated in FIG. 6B, the resist film 16 is developed, the resist film 16 remaining after the removal of the exposed portions forms the desired concave-convex pattern P′. A conductive film (not shown) is provided on the concave-convex pattern P′ by means of, for example, sputtering, electroplating or electroless plating to produce an electroformable matrix 17. As materials for the conductive film there may be used simple substance metal such as Ni, Fe, or Co or alloy thereof.

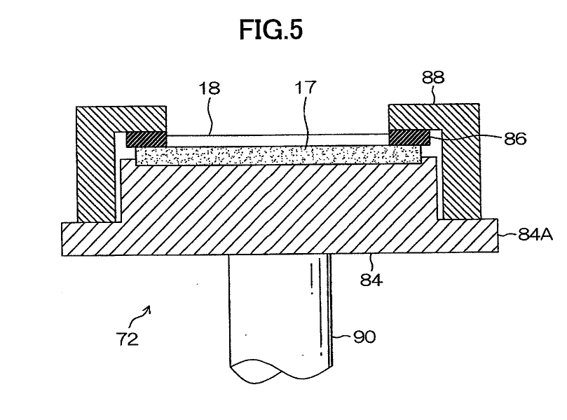

As illustrated in FIG. 6C, the entire face of the matrix 17 is subjected to an electroforming process by the electroforming apparatus 60 illustrated in FIG. 4. The electroforming apparatus 60 includes a plating tank 64 for storing plating liquid (bath) 62, a drain tank 66 for receiving the plating liquid 62 overflowing the plating tank 64, an anode chamber 70 which is filled with Ni pellets 68 as anode and receives the plating liquid 62 overflowing the plating tank 64 and a cathode 72 for holding the matrix and so on.

In the electroforming apparatus 60 with the above configuration, the cathode 72 holds the matrix 17 and is connected to a negative electrode, and the anode chamber 70 is connected to the positive electrode to energize, thereby electroforming the master substrate 11.

As the electroforming layer there may be used various metals or alloys, in the present embodiment, however, Ni metal is deposited to form the metallic disk 18 (or Ni electroforming layer) with a predetermined thickness. Ni has a crystal structure of a face centered cubic lattice. Electroforming is performed such that current density at the time of electroforming is controlled to form a specified crystal structure.

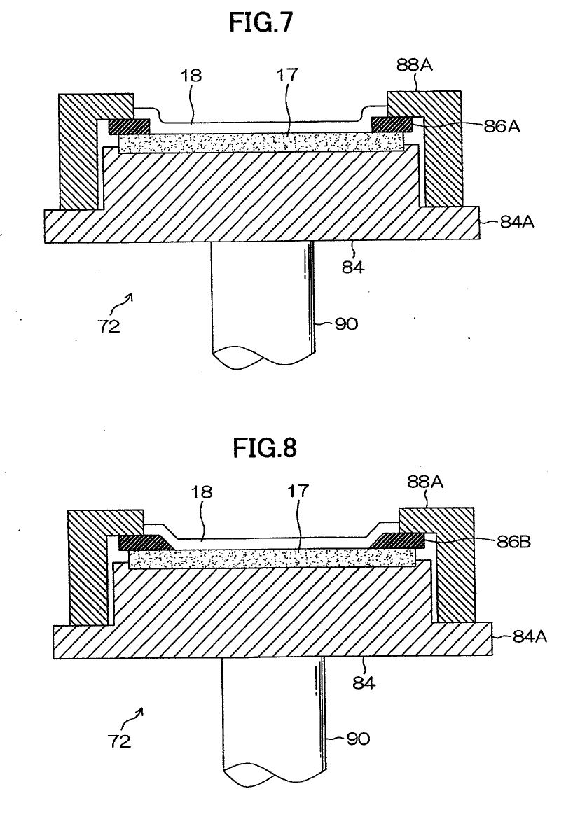

As illustrated in FIG. 7, the cathode 72 includes a cathode main body 84 being a disklike member with a flange portion 84A, a conduction ring 86A, a presser ring 88A and a shaft 90. The matrix 17 can be placed on the surface of the cathode main body 84 in this state (attitude) in FIG. 7.

The conduction ring 86A is arranged on the matrix 17 and has a bore diameter which is 1.5 times or more as large as the outer diameter of a master information carrier to be produced. The inner peripheral surface of the conduction ring 86A is filed to form fine concave-convex pattern. As materials for the conduction ring 86A there may be used various kinds of metallic materials, for example, stainless steel or titanium, which do not cause degradation such as rust owing to the use of them in the electroforming apparatus 60.

The presser ring 88A is a ring member which is larger by 2 mm or more in bore diameter than the conduction ring 86A and prevents the conduction ring 86A and the matrix 17 from coming off from the cathode main body 84 when the presser ring 88A is set to the cathode main body 84 (for example, fixed to the cathode main body 84 by a bolt member (not shown)). As materials for the presser ring 88A there may used various kinds of resin materials such as, for example, polyvinyl chloride (PVC).

The shaft 90 is a cylindrical member which is detachably fixed to the central portion of the lower face of the cathode main body 84. As materials for the shaft 90 there may be used various kinds of metallic materials which do not cause degradation such as rust owing to the use of them in the electroforming apparatus 60.

Aside from the configuration of the cathode 72 illustrated in FIG. 7, the cathode 72 used in the method for manufacturing a master information carrier for magnetic transfer according to the present invention may include a cathode main body 84 being a disklike member with a flange portion 84A, a conduction ring 86B, a presser ring 88A and a shaft 90 as illustrated in FIG. 8.

As is the case with the conduction ring 86A, the conduction ring 86B is arranged on the matrix 17 and has a bore diameter which is 1.5 times as large as the outer diameter of a master information carrier to be produced. The inner peripheral surface of the conduction ring 86B is tapered down. The surface of the tapered portion is filed to form a fine concave-convex pattern. As materials for the conduction ring 86B there may be used various kinds of metallic materials, for example, stainless steel or titanium, which do not cause degradation such as rust owing to the use of them in the electroforming apparatus 60.

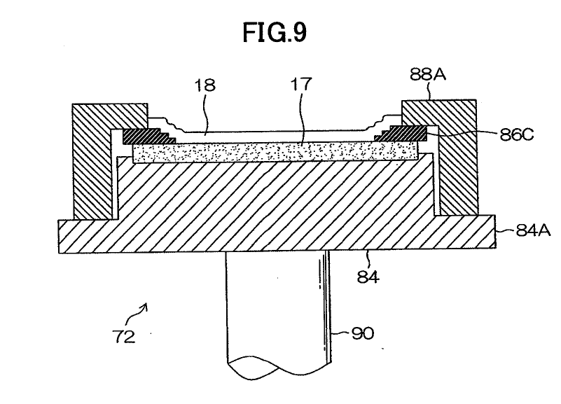

Aside from the configurations of the cathode 72 illustrated in FIGS. 7 and 8, the cathode 72 used in the method for manufacturing a master information carrier for magnetic transfer according to the present invention may include a cathode main body 84 being a disklike member with a flange portion 84A, a conduction ring 86C, a presser ring 88A and a shaft 90 as illustrated in FIG. 9.

As is the case with the conduction rings 86A and 86B, the conduction ring 86C is arranged on the matrix 17 and has a bore diameter which is 1.5 times as large as the outer diameter of a master information carrier to be produced. The inner peripheral surface of the conduction ring 86C is stepped. The surface of the stepped portion is filed to form a fine concave-convex pattern. As materials for the conduction ring 86C there may be used various kinds of metallic materials, for example, stainless steel or titanium, which do not cause degradation such as rust owing to the use of them in the electroforming apparatus 60.

The inner peripheral surface of these conduction rings may be so formed as to have a stepped or a tapered surface. Alternatively, the inner peripheral surface of the conduction rings may be of a shape formed by combining the stepped surface with the tapered surface.

By these conduction rings 86A, 86B and 86C, the metallic disk 18 deposited on the matrix 17 is deposited not only on the inner peripheral surfaces of the conduction rings 86A, 86B and 86C, but also on the plane portions of the conduction rings 86A, 86B and 86C to be integrated with the conduction rings 86A, 86B and 86C, preventing the metallic disk 18 from coming off from the conduction rings 86A, 86B and 86C. For this reason, even if an unnecessary external force is applied to the metallic disk 18, the metallic disk 18 does not come off from the conduction ring, which reduces the distortion of the metallic disk 18. Thereby, a high quality master information carrier for magnetic transfer can be produced.

Returning to FIG. 6, the metallic disk 18 with the aforementioned specified crystal structure is detached from the matrix 17 and the remaining resist film 16 is removed and washed. Thus, as illustrated in FIG. 6D, an original disk 11′ of the master substrate 11 is obtained. The original disk 11′ has a reversed concave-convex pattern P, and an outer diameter D which has not yet been punched to a predetermined size.

The original disk 11′ is punched to produce the master substrate 11 with the predetermined size of an outer diameter “d” as illustrated in FIG. 6E. Depositing the magnetic layer 12 on the surface of the concave-convex pattern of the master substrate 11 allows the master disk 10 to be produced.

Incidentally, the matrix 17 is electroformed to produce a second matrix as another production process of the master disk 10. The second matrix is used to perform electroforming to produce a metallic disk with a reversed concave-convex pattern. The metallic disk may be punched to a predetermined size to produce a master substrate.

Furthermore, first, a third matrix may be produced by electroforming on the second matrix, or by pressing resin liquid against the second matrix and hardening the liquid. In addition, a metal disk with the reversed concave-convex pattern may be produced by electroforming on the third matrix. Thereafter, a master substrate may be produced by detaching the metal disk. The second and the third matrix may be repetitively used to produce a plurality of the metallic disks 18.

In the production of the matrix, after the resist film has been exposed and developed, the resist film is etched to form the concave-convex pattern on the surface of the matrix and then the resist film may be removed.

The magnetic layer 12 is formed such that a magnetic material is deposited by vacuum deposition methods such as vacuum deposition, sputtering or ion plating or by plating method or coating. As magnetic materials for the magnetic layer there may be used Co, Co alloy (CoNi, CoNiZr, CoNbTaZr or the like), Fe or Fe alloy (FeCo, FeCoNi, FeNiMo, FeAlSi, FeAl, FeTaN or the like), Ni, Ni alloy (NiFe etc.). In particular, FeCo or FeCoNi may be preferably used. The magnetic layer 12 is preferably 10 nm to 500 nm in thickness, and more preferably 10 nm to 400 nm.

A protective film such as diamond-like carbon (DLC) or sputtering carbon is preferably provided on the magnetic layer 12 and a lubricant layer may be further provided on the protective film. In this case, it is preferable to form the lubricant layer on a 3-nm to 300-nm thick DLC film.

An adherence strengthening layer made of Si etc. may be provided between the magnetic layer and the protective layer. The lubricant is effective to improve degradation in durability caused by scratches formed by friction at the time of correcting a shift caused by the touching process with the slave disk 14.

In the present invention, the Ni electroforming layer with a very small residual stress is formed by controlling current density and time when the metallic disk 18 is deposited by the electroforming process.

Although metal generally used as the master disk 10 is nickel (Ni), nickel sulfamate bath from which the master substrate 11 small in stress can be easily obtained is preferably used when the master disk 10 is produced by electroforming.

The nickel sulfamate bath is one in which additive such as detergent (for example, sodium lauryl sulfate) based on nickel sulfamate of 400 g/L to 800 g/L and boric acid of 20 g/L to 50 g/L (supersaturation) is added if required. The bath temperature of plating bath is preferably 40° C. to 60° C. A nickel ball housed in a titanium case is preferably used in a counter electrode during electroforming.

### Embodiment

The following is a description of a concrete embodiment of the method for manufacturing a master information carrier for magnetic transfer according to the present invention.

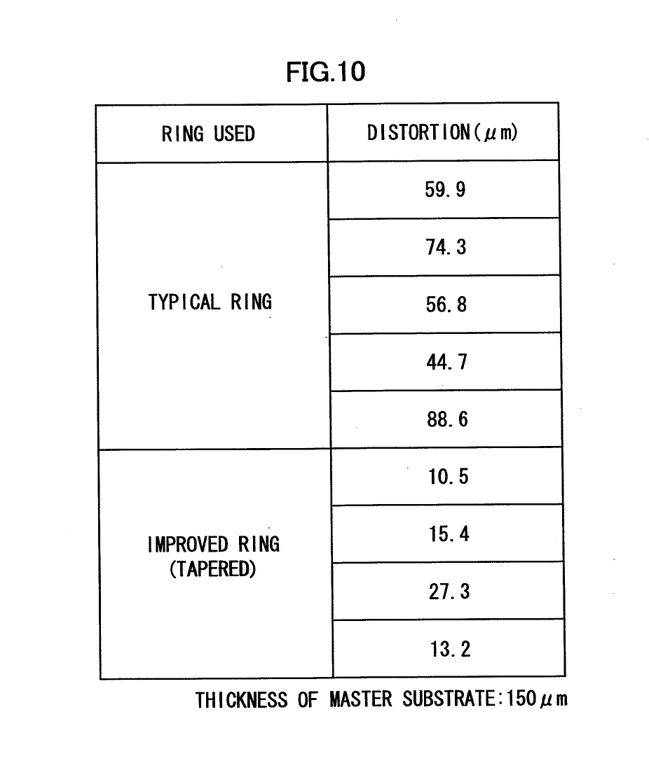

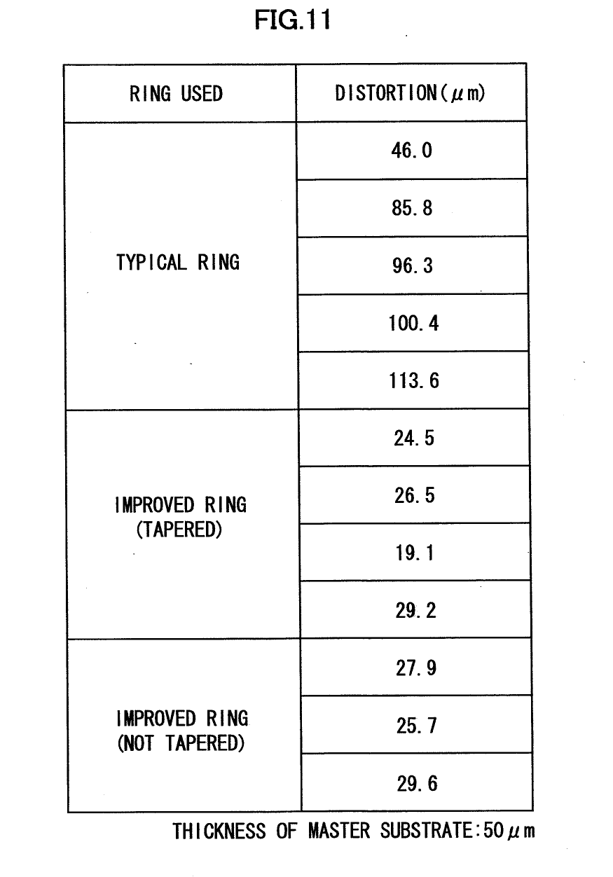

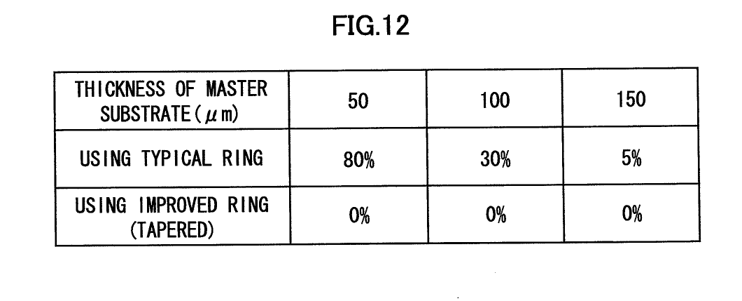

FIGS. 10 and 11 are tables in which a comparison is made between distortions in the master substrate 11 in the cases where electroforming is performed using a typical conduction ring and where electroforming is performed using the conduction rings 86A and 86B according to the present embodiment of the present invention. FIG. 12 is a table in which a comparison is made between the probabilities that the metallic disk 18 comes off when a typical conduction ring is used and when the conduction ring according to the present embodiment is used.

The typical conduction ring 86 used in the present embodiment, illustrated in FIG. 5, is made of “Steel Use Stainless” (SUS), 193 mm in bore diameter, 1 mm in thickness and 16 mm in ring width. The conduction ring 86A illustrated in FIG. 7 is made of “Steel Use Stainless” (SUS), 180 mm in bore diameter, 1 mm in thickness and 22.5 mm in ring width. The conduction ring 86B illustrated in FIG. 8 is made of “Steel Use Stainless” (SUS), 180 mm in bore diameter, 1 mm in thickness and 22.5 mm in ring width as is the case with the conduction ring 86A and the inner peripheral surface thereof is tapered. The bore diameter of the presser rings 88 and 88A is 193 mm which is the same as that of the conduction ring 86.

Electroforming was carried out using the above conduction rings with use of the electroforming apparatus 60. After electroforming had been performed, the master substrate 11 with an outer diameter of 65 mm and a bore diameter of 24 mm was formed through a detaching, a washing and a punching process.

Distortion is measured such that the master substrate 11 is placed on a surface plate to measure displacement by a laser displacement gauge while the master substrate 11 is being rotated one cycle. After displacement has been measured while the master substrate 11 has been being rotated one cycle, the average value of displacement per revolution is determined. A position where measurement is performed by the laser displacement gauge is moved in the radial direction and the average value of displacement per revolution is determined again. This is repeated several dozen times. A difference between the maximum and the minimum value of displacement in the circumferential direction remaining after the average value of displacement is subtracted is taken to be distortion.

The probability that the metallic disk 18 comes off from the conduction ring is represented by a ratio of the number of the metallic disks 18 which came off from the conduction ring while the metallic disk 18 was detached, washed and punched on the master substrate 11 with each thickness after electroforming, to the total number of the electroformed metallic disks 18.

A comparison is made as to distortion of the 150-μm thick master substrate 11. The following were produced and measured: five master substrates 11 with typical conduction rings 86; and four master substrates 11 with conduction rings 86B with tapered portions.

As shown in FIG. 10, the maximum value of distortion in the case where the conduction rings 86 were used was 88.6 μm and the minimum value was 44.7 μm. On the other hand, the maximum value of distortion in the case where the conduction rings 86B were used was 27.3 μm and the minimum value was 10.5 μm, which means that the master substrates 11 manufactured by using conduction rings 86B are smaller in distortion than the master substrates 11 manufactured by using the conventional typical conduction rings 86, enabling manufacturing a high quality master information carrier for magnetic transfer which is smaller in distortion.

In the next place, a comparison is made as to distortion of the 50-μm thick master substrate 11. The following were produced and measured: five master substrates 11 with typical conduction rings 86; four master substrates 11 with conduction rings 86B with tapered portions; and three master substrates 11 with conduction rings 86A smaller in bore diameter than the conduction rings 86.

As shown in FIG. 11, the maximum value of distortion in the case where the conduction rings 86 were used was 113.6 μm and the minimum value was 46.0 μm. On the other hand, the maximum value of distortion in the case where the conduction rings 86B were used was 29.2 μm and the minimum value was 19.1 μm. The maximum value of distortion in the case where the conduction rings 86A were used was 29.6 μm and the minimum value was 25.7 μm. This means that the master substrates 11 manufactured by using conduction rings 86A or 86B are smaller in distortion than the master substrates 11 manufactured by using the conventional typical conduction rings 86, enabling manufacturing a high quality master information carrier for magnetic transfer which is smaller in distortion.

Next, in cases where 10 to 50 master substrates 11 with a thickness of 50 μm, 100 μm and 150 μm are made, respectively. The probabilities that the metallic disks 18 come off from the conduction ring 86 are compared. As shown in FIG. 12, the probabilities that the metallic disks 18 on the master substrates 11 with a thickness of 50 μm, 100 μm and 150 μm came off from the typical conduction rings 86 were 80%, 30% and 5% respectively. On the other hand, the probabilities that the metallic disks 18 on the master substrates 11 with a thickness of 50 μm, 100 μm and 150 μm came off from the conduction rings 86B with tapered portions were 0%, that is to say, the metallic disks 18 did not come off from the conduction rings 86B irrespective of the thickness of the master substrates.

As described above, according to the method for manufacturing a master information carrier for magnetic transfer according to the embodiments of the present invention, the electroformed metallic disk is more tightly integrated with the conduction ring to prevent the metallic disk from coming off from the conduction ring, reducing distortion in the master information carrier, which allows manufacturing a high quality master information carrier for magnetic transfer.

What is claimed is:

1. A method for manufacturing a master information carrier for magnetic transfer on the surface of which a concave-convex pattern corresponding to transfer information is provided, comprising the step of:
arranging a conduction ring on a matrix on the surface of which a concave-convex pattern corresponding to transfer information is formed; and
forming a metallic layer by electroforming on the matrix, wherein
the conduction ring is smaller in bore diameter than a presser ring which fixes the conduction ring and the matrix.

2. The method for manufacturing a master information carrier for magnetic transfer according to claim 1, wherein
the metallic layer is electroformed on the matrix, the inner peripheral surface of the conduction ring and a plane portion of the conduction ring, the plane portion where the presser ring does not touch.

3. The method for manufacturing a master information carrier for magnetic transfer according to claim 1, wherein
a concave-convex pattern is formed on the surface of the inner peripheral surface of the conduction ring.

4. The method for manufacturing a master information carrier for magnetic transfer according to claim 1, wherein
the bore diameter of the presser ring is larger than that of the conduction ring and
the bore diameter of the conduction ring is larger than the outer diameter of the master information carrier.

5. The method for manufacturing a master information carrier for magnetic transfer according to claim 1, wherein
the bore diameter of the conduction ring is 1.5 times or more as large as the outer diameter of the master information carrier.

6. The method for manufacturing a master information carrier for magnetic transfer according to claim 1, wherein
the bore diameter of the presser ring is larger by 2 mm or more than that of the conduction ring.

7. The method for manufacturing a master information carrier for magnetic transfer according to claim 1, wherein
the inner peripheral surface of the conduction ring is tapered.

8. The method for manufacturing a master information carrier for magnetic transfer according to claim 1, wherein
the inner peripheral surface of the conduction ring is stepped.

9. The method for manufacturing a master information carrier for magnetic transfer according to claim 7, wherein
the metallic layer is electroformed on the matrix, the inner peripheral surface of the conduction ring and a plane portion of the conduction ring, the plane portion where the presser ring does not touch.

10. The method for manufacturing a master information carrier for magnetic transfer according to claim 7, wherein
a concave-convex pattern is formed on the surface of the inner peripheral surface of the conduction ring.

11. The method for manufacturing a master information carrier for magnetic transfer according to claim 7, wherein
the bore diameter of the presser ring is larger than that of the conduction ring and
the bore diameter of the conduction ring is larger than the outer diameter of the master information carrier.

12. The method for manufacturing a master information carrier for magnetic transfer according to claim 7, wherein
the bore diameter of the conduction ring is 1.5 times or more as large as the outer diameter of the master information carrier.

13. The method for manufacturing a master information carrier for magnetic transfer according to claim 7, wherein
the bore diameter of the presser ring is larger by 2 mm or more than that of the conduction ring.
